(19) United States
(12) Patent Application Publication
(10) Pub. No.: US 2019/0050998 A1
(43) Pub. Date: Feb. 14, 2019

(54) Scene Flow Camera

(71) Applicant: Richard Kirby, Heber City, UT (US)

(72) Inventor: Richard Kirby, Heber City, UT (US)

(21) Appl. No.: 15/673,453

(22) Filed: Aug. 10, 2017

(51) Int. Cl. G06T 7/285; G06T 7/593; H04N 13/02; G06T 7/38

(52) U.S. Cl. CPC G06T 7/285; G06T 7/593; H04N 13/0239; H04N 13/0271; G06T 2207/10048; G06T 2207/10021; G06T 2207/10024; G06T 2207/10028; G06T 7/38

(57) ABSTRACT

A method and system for acquiring dense 3D depth maps and scene flow using a plurality of image sensors, each image sensor associated with an optical flow processor, the optical flow fields being aligned to find dense image correspondences. The disparity and/or ratio of detected optical flows in corresponding pixels combined with the parameters of the two optical paths and the baseline between the image sensors is used to compute dense depth maps and scene flow.

### CROSS-REFERENCE TO RELATED APPLICATIONS

This application claims the benefit of U.S. provisional applications No. 62/374,998 filed 15 Aug. 2016 and No. 62/411,837, filed 24 Oct. 2017.

### FEDERALLY SPONSORED RESEARCH

Not applicable.

### SEQUENCE LISTING OR PROGRAM

Not applicable.

### BACKGROUND OF THE INVENTION

### Field of Invention

This invention relates to an optical apparatus for the measurement of scene flow and more particularly to an optical apparatus which combines optical flow images acquired at two different image sensor poses and aligns the optical flow fields to estimate the scene flow (structure and motion) of the 3D scene.

### Prior Art

Scene flow is the dense or semi-dense 3D motion field of a scene with respect to an observer. Applications of scene flow are numerous, including autonomous navigation in robotics, manipulation of objects in dynamic environments where the motion of surrounding objects needs to be predicted, improved Visual Odometry (VO) and Simultaneous Localization And Mapping (SLAM) algorithms, analysis of human performance, human-robot or human-computer interaction, and virtual and augmented reality.

The traditional method of computing scene flow employs a multi-camera rig which acquires pairs of image sequences. Images taken from the two different cameras at the same time are used to compute a dense depth map using stereo correspondence finding algorithms that use a measure of visual similarity between simultaneous pairs of images to match pixels that represent the same point in the 3D scene. Images taken sequentially in time from one of the cameras are used to compute optical flow. Scene flow is then determined by projecting the optical flow field into the 3D scene using the estimated depth and knowledge of the camera parameters.

This methodology, however, is prone to errors inherent in all correspondence finding algorithms, namely that finding accurate correspondences rely on the use of visual similarity in the pairs of images to match corresponding pixels. While visual similarity measures produce good results in laboratory experiments, they often fail in real world situations where the lighting for the cameras at different poses is not identical (a common situation in real world imaging where surfaces reflect different amounts of light in different directions), where the cameras image different frequencies of light (a desirable situation in robotics, autonomous vehicles and surveillance where there are significant benefit for using a combination of visible light and infrared light) or where the camera images are noisy (common in low light conditions).

Kirby (U.S. Pat. No. 8,860,930) describes an apparatus that comprises a pair of cameras that have substantially coaxial optical paths that uses a mathematical singularity that occurs on the optical axis of a coaxial camera rig to determine distance and scene flow at a point by using the ratio of the optical flow. Because the optical flow field is invariant to different illumination, this method overcomes the problems with using visual similarity to find image correspondences. To acquire depth at every point in the scene, however, U.S. Pat. No. 8,860,930 describes a system which scans the scene. More recently, this applicant in the paper “3D reconstruction from images taken with a coaxial camera rig”, Proc. SPIE 9971, Applications of Digital Image Processing XXXIX, 997106 (Sep. 27, 2016), describe a coaxial system for acquiring dense depth maps (a depth value for every non-occluded pixel) using a pair of image sensors aligned coaxially. Additionally, this applicant describes a multi-modal camera rig in “A novel automated method for registration and 3D reconstruction from multi-modal RGB/IR image sequences”, Proc. SPIE 9974, Infrared Sensors, Devices, and Applications VI, 99740O (Sep. 19, 2016), which uses a pair of image sensors that image different frequencies of light, which is also capable of estimating dense depth maps. In addition to the above two publications, more details of the system are provided by this applicant in “Image correspondences from perceived motion”, in the Journal of Electronic Imaging (February 2017) and in “Image Correspondences From Perceived Motion” April 2017, ProQuest Dissertations Publishing, 2017.10268238. In the above cited publications, the reliance on the mathematical singularity used in U.S. Pat. No. 8,860,930 which occurs only on the optical axis and only in images taken with coaxially aligned cameras, has been overcome.

### SUMMARY OF THE INVENTION

This invention discloses a camera rig that finds image correspondences by aligning pairs of image sequences using the variations in the optical flow fields obtained from cameras at different poses. The optical flow fields provide information about the structure and motion of the scene which is not available in still images, but which can be used in image alignment. Optical flow fields are invariant to the frequency of the light being imaged as well as to the intensity of light, which means images taken at different light frequencies can be aligned. Additionally, because optical flow is used in both cameras, common problems in the computation of optical flow cancel out. This results in a camera rig that produces more accurate depth and scene flow estimation than state-of-the-art devices as well as it produces scene flow from multi-modal cameras and coaxial cameras, which is not possible with the current state-of-the-art. Furthermore, because the ratio of the optical flow fields are used to compute depth, camera orientations which produce zero disparity (coaxial cameras for example) can be used to acquire dense depth maps and scene flow. This allows 3D imaging through a tube such as a borescope or endoscope, where traditional multicamera rigs do not work.

### Objects and Advantages

Accordingly, several objects and advantages of the present invention are:
(1) to provide a system that acquires pairs of sequential images, the image pairs within the temporal image sequences taken from different poses and substantially at the same time.
(2) to provide a system which computes the perceived motion (optical flow) fields from each image sequence.
(3) to provide a system that aligns the images using the perceived motion (optical flow) fields in the image sequences.
(4) to provide a system that estimates depth from the aligned image pairs at substantially every non-occluded pixel.
(5) to provide a system that estimates the 3D scene flow from the estimated depth and optical flow.
(6) to provide a system which produces dense depth maps and 3D scene flow through a tube

Further objects and advantages of this invention will become apparent from a consideration of the drawings and ensuing descriptions.

### SUMMARY

According to one embodiment of the present invention, a multi-camera rig comprising a plurality of image sensors, each image sensor sensing a range of light frequencies, each image sensor associated with an optical flow processor, and the first image sensor imaging a portion of the scene in common with the second image sensor such that corresponding points in images acquired by the image sensors represent the same point in the 3D scene. Two sets of optical flow fields are computed, one from each camera, using sequential images. These two optical flow fields are aligned using an energy minimization optimization technique. The pixel disparity combined with the difference in the magnitude of the optical flow fields that result from the aligned flow fields can be used to align the images from the two sensors, resulting in superposition of the two images such that the same point in the scene is represented by the same pixel location in the superposed images. The ratio of the aligned optical flows combined with the disparity and the parameters of the two optical paths are used to compute a Z-distance for every pixel in the image that has a corresponding matching pixel in the other image. This produces a dense depth maps, a map of Z-distances where each non-occluded pixel is associated with a Z-distance. The dense depth maps are then converted into 3D images or into traditional binocular stereo image pairs for viewing using standard 3D rendering techniques. Dense depth maps are used to project the optical flow to 3D scene flow.

This method substantially overcomes the issues with the previously mentioned means of aligning images from sensors using visual similarity, by using the optical flow field, a projection of the scene motion, to perform the alignment.

### BRIEF DESCRIPTION OF THE DRAWINGS

FIG. 1 is a schematic representation showing the optical system, imaging system and image processing system of a preferred embodiment of the scene flow camera.

FIG. 2 is a block diagram of a preferred embodiment of the scene flow camera with integrated optical flow sensors.

FIG. 3 is a software flow chart of the operation of a preferred embodiment of the scene flow camera.

FIG. 4 is an illustration of an additional preferred embodiment of the scene flow camera where the image sensors and optical flow processors are discrete components.

FIG. 5 is a block diagram of an additional preferred embodiment of the scene flow camera where the optical flow algorithms are implemented as subroutines in the processor's software.

FIG. 6 is a schematic representation an additional preferred embodiment of the scene flow camera where the image sensors are aligned coaxially.

FIG. 7 is a schematic diagram of the side view relationship between the images in a multimodal camera imaging system as well as the side view and top view relationship between the images in a coaxial camera system.

FIG. 8 is a schematic diagram of the top view relationship between the images in a stereo camera imaging system.

### DRAWINGS

### REFERENCE NUMERALS

205 first image sensor, imaging first light frequency range

206 second image sensor, imaging second light frequency range

210 first optical flow processor

211 second optical flow processor

215 first imaging lens

220 second imaging lens

225 3D reconstruction processor

230 multi-camera rig

235 first focal length

240 second focal length

255 optical axis of first image sensor

256 optical axis of second image sensor

265 image processor

270 processor or computer

275 memory

280 input/output devices

285 first optical flow sensor imaging first range of light frequencies

286 second optical flow sensor imaging second range of light frequencies

295 initialization

300 request to each image sensor to take a new image at Δt seconds

305 optical flow computation

320 optical flow field alignment method

325 compute dense depth map method

330 save 3D data

335 render and display 3D data

340 stream 3D data

345 done

355 first image sensor, imaging light in first light frequency range

356 second image sensor imaging light in second light frequency range

360 first optical flow processor

365 second optical flow processor

370 optical axis of first image sensor

375 optical axis of second image sensor

380 first imaging lens

385 second imaging lens

405 cross sectional view of first image sensor

410 cross sectional view of second image sensor

415 point in scene

505 first image sensor

506 second image sensor

515 first imaging lens

520 second imaging lens

530 Coaxial camera optical system, image sensors, and image processing and reconstruction systems

540 surface in 3D scene

545 beam splitter

547 mirror

555 coaxial optical path

556 first independent optical path

557 second independent optical

### DETAILED DESCRIPTION

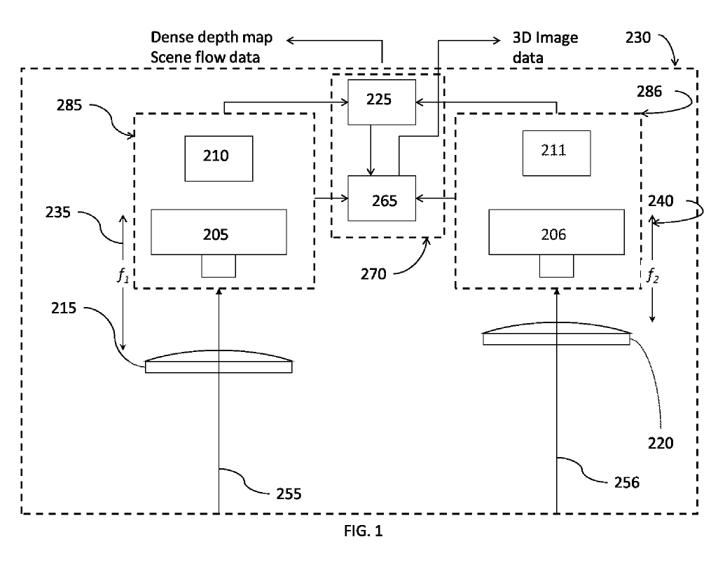

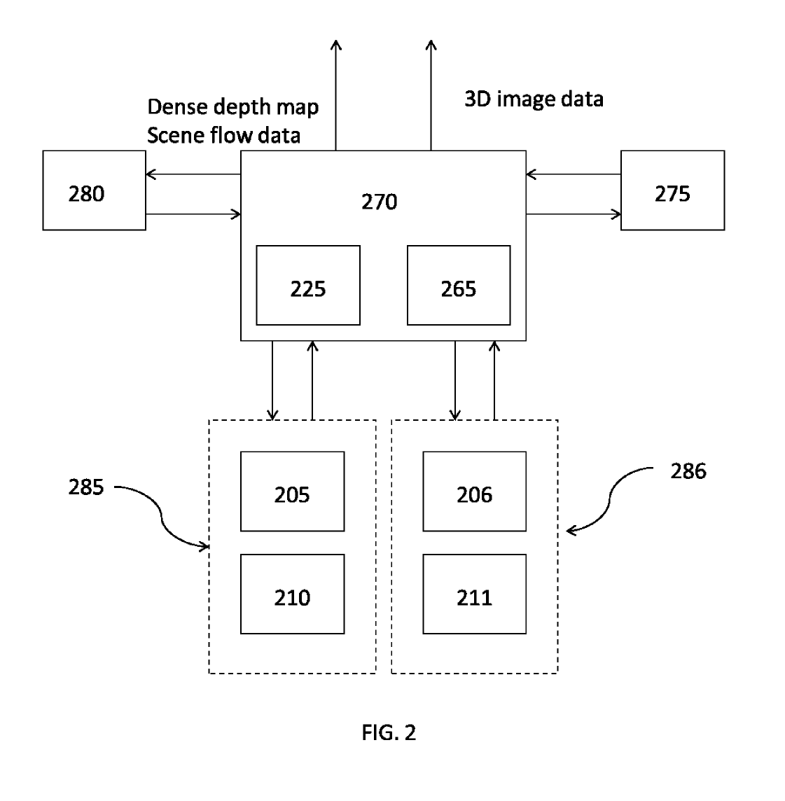

### FIGS. 1-2—Preferred Embodiment

FIG. 1 is a schematic representation showing the optical system, imaging system and image processing system of a preferred embodiment of the scene flow camera. A first optical flow sensor imaging first range of light frequencies 285 comprised of a first image sensor, imaging first light frequency range 205 and a first optical flow processor 210, image along an optical axis of first image sensor 255 via a first imaging lens 215 having a first focal length 235. A second optical flow sensor imaging second range of light frequencies 286 comprised of a second image sensor, imaging second light frequency range 206 and a second optical flow processor 211, image along an optical axis of second image sensor 256 via a second imaging lens 220 having a second focal length 240. The image formed in the first image sensor, imaging first range of light frequencies 205 having a partial overlap with the image formed in the second image sensor, imaging a second light frequency range 206.

In the preferred embodiment, the optical axis of the first image sensor 255 and the optical axis of second image sensor 256 are parallel, however as one skilled in the art will readily understand, the optical axes need not be parallel as long as the images are of an overlapping sub-region of the scene. If images that appear to have parallel optical axes are desired, a well-known image processing technique called “image rectification” can be used to convert images that were taken with non-parallel optical axes into images that appear to have been taken with parallel optical axes. One skilled in the art could conceive of other camera orientations, including the coaxial camera orientation, which will produce images with sufficient overlap to align the optical flow fields.

In preferred embodiment, the first focal length 235 is different from the second focal length 240, but one skill in the art can appreciate that the same focal length can be used in the two imaging systems. Additionally, in the preferred embodiment the distance along the optical axis of first image sensor 255 between the first imaging lens 215 and the scene is different than the distance along the optical axis of second image sensor 256 between the second imaging lens 220 and the scene.

While one preferred embodiment uses an integrated optical flow sensor, in another preferred embodiment the image sensor, sensing first light frequency range 205 and the first optical flow processor 210 are discrete components. Additionally, the first optical flow processor 210 may be a computer program implemented on a general-purpose processor, in an Field Programmable Gate Array (FPGA), Application Specific Integrated Circuit (ASIC), discrete state engine, a graphic processing unit or similar device. One skilled in the art will be able to conceive of numerous ways of implementing a combination image sensor and optical flow processor.

The first image sensor, sensing first light frequency range 205 may have a range of pixel counts and resolutions as well as frame rates. In one preferred embodiment, the first image sensor 205 is 640×480 pixels, each pixel being 4.8 μm×4.8 μm, having a frame rate of 30 fps, and detecting color images. Image sensors with any size pixels and a range of frames rate could also be used as long as there is sufficient overlap between sequential images to produce optical flow. Monochrome image sensors may be used. IR image sensors may be used. In one preferred embodiment, the first imaging lens 215 has a first focal length 235 of 6 mm. The imaging system may have lenses comprised of multiple optical components, a single lens or may use a pinhole to form the image. One skilled in the art will have no difficulty designing an imaging system capable of producing an image on the image plane of first image sensor, sensing first light frequency range 205.

The second image sensor, sensing second light frequency range 206 may have a range of pixel counts and resolutions as well as frame rates. In one preferred embodiment, the second image sensor 206 is 640×480 pixels, each pixel being 4.8 μm×4.8 μm, having a frame rate of 30 fps, and detecting IR images. The pixel count, pixel size, and frame rate need not be the same as the first image sensor, imaging first light frequency range 205. Image sensors with any size pixels and a range of frames rate could be used. Color image sensors may be used. Monochrome image sensors may be used. In one embodiment, the second imaging lens 220 has the second focal length 240 of 8 mm. The imaging system may have multiple lenses or may use a pinhole to form the image. One skilled in the art will have no difficulty designing an imaging system capable of producing an image on the image planes of second image sensor, sensing second light frequency range 206.

The two light frequency ranges image by the two image sensors 205 and 206 may be the same or they may be different.

The first image sensor imaging first light frequency range 205 is in communication with the first optical flow processor 210 and the second image sensor imaging second light frequency range 206 is in communication with the second optical flow processor 211. In one preferred embodiment, the integrated optical flow sensors 285 and 286 are Pixhawk PX4flow. One skilled in the art will appreciate the variety of available integrated optical flow sensors and will have no difficulty selecting a suitable one for the application.

In addition to being in communication with optical flow processors 210 and 211 the images acquired by the first image sensor, imaging first light frequency range 205 and the second image sensor, imaging second light frequency range 206 may be in communication with an image processor 265 which combines the dense depth map with the 2D image data to output rendered 3D image data.

The output of the optical flow field from each of the optical flow processors is fed into a 3D reconstruction processor 225 that aligns pairs of flow fields and uses the aligned flow fields to compute dense depth maps. The algorithm used by the 3D reconstruction processor 225 is described under the operation section of this application. In one preferred embodiment, the 3D reconstruction processor 225 and the image processor 265 are implemented in subroutines in processor 270, but one skilled in the art can appreciate that these functions could be implemented numerous different ways including in discrete components or separate dedicated processors.

FIG. 2 is a block diagram of the 3D surface mapping system. The components of the system are in communication with the processor 270 which could be computer code running on a computer processor, discrete logic components, or any number of other implementations familiar to one skilled in the art. In the preferred embodiment, processor 270 is in communication with the integrated optical flow sensors 285 and 286 and can send control commands to both the image sensors 205 and 206, both the optical flow processors 210 and 211 as well as receive optical flow data and images.

In FIG. 2, processor 270 is in communication with a memory 275 and input/output devices 280 which could be any combination of displays, keyboards, mice, 3D virtual reality goggles, or any other input/output device known to those skilled in the art. The processor 270 also streams 3D position data, 3D velocity data, and 3D image data.

### Operation—FIG. 1-7

In FIG. 1, image sensor, sensing first light frequency range 205 in the first optical flow sensor imaging first range of light frequencies 285, takes sequential images of a 3D scene. In a preferred embodiment the frame rate of the first image sensor, sensing first light frequency range 205 is 30 frames per second, but a wide range of frame rates could be used. The frame rate is dependent on the movement of the surface or surfaces in the 3D scene and the optical flow algorithm being used. Optical flow algorithms depend on image overlap between image frames. One skilled in the art will be able to select appropriate frame rates and optical system magnifications to ensure that the optical flow algorithm chosen has sufficient overlap between images.

Sequential images (image n and image n+1) are taken at times t and t+Δt and the pair of images are sent to the first optical flow processor 210 and the second optical flow processor 211. In the preferred embodiment, the imaging system is designed such that under expected relative motion the image moves between 1 and 30 pixels between sequential images although wider ranges are possible and fractional pixel displacements are also possible.

Surfaces moving faster or surfaces which are closer to the first image sensor, sensing first light frequency range 205 will show larger perceived velocity vectors. The relationship between the distance to the surface being imaged and the shift in brightness patterns follows the projection equation which is well known to one skilled in the art. The projection equation mathematically describes how a point on the 3D surface in the scene maps to a pixel in the 2D image taken by the first image sensor, sensing first light frequency range 205 and by the second image sensor, sensing second light frequency range 206.

At substantially the same time as the first image sensor, sensing first light frequency range 205 takes images n and n+1, the second image sensor, sensing second light frequency range 206 takes images p and p+1. Because the first focal length 235 is different from the second focal length 240 in the preferred embodiment, the magnification of the image of the 3D scene formed on the image plane of the second image sensor, sensing second light frequency range 206 varies differently with changing Z-distances relative to the magnification of the image formed on the image plane of the first image sensor, sensing first light frequency range 205. Sequential images (image p and image p+1) taken at times t and t+Δt by the second image sensor, sensing second light frequency range 206 are sent to optical flow processor 211.

The difference in magnification of each optical path results in the optical flow vectors from the first optical flow processor 210 and from the second optical flow processor 211 being proportional to each other by the difference in magnification of the optical systems.

The outputs of the two optical flow processors 210 and 211 are in communication with the 3D reconstruction processor 225. The two optical flow fields are aligned using an energy minimization optimization to find corresponding pixels from the image pairs that are a projection of the same point in the 3D scene, then the combination of the ratio of the optical flow and the disparity between pixels with corresponding optical flows is used to compute the Z-distance for each pixel, resulting in a dense depth map. The dense depth map in combination with the optical flow fields are used to reconstruct the relative 3D motion between the multimodal camera rig and the 3D scene.

### Operation—Optical Flow Field Alignment: Energy Functional

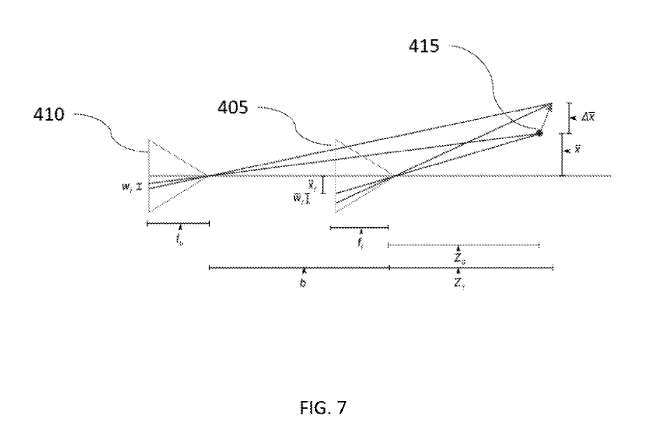

FIG. 7 is a side view of a preferred embodiment of the scene flow camera. In FIG. 7 x̅ₗ:=(xₗ, yₗ)^{T}, x̅ᵣ:=(xᵣ, yᵣ)^{T} represent points in the image domain of a first cross-sectional view of first image sensor 405 and a cross sectional view of second image sensor 410. h̅(x̅):=the disparity between x̅ₗ and x̅ᵣ such that x̅ₗ and x̅ᵣ+h̅(x̅ᵣ) represent a point in the scene 415 at X̅(x̅ₗ):=(X, Y). fₗ, fᵣ:=the focal lengths of the first and second optical systems and Zₗ₀(x̅ₗ), Zₗ₁(x̅ₗ):=the distance between the optical center of the first and second image sensors and a point in the scene corresponding to x̅ₗ at time t=0 and t=1, the distance being measured along the optical axis. ΔZ(x̅ₗ) is then the difference along the Z axis for each point between t=0 and t=1. X̅:=the distance from the optical axis to a point in the scene and ΔX̅:=the change in the distance from the optical axis between time t=0 and t=1. b:=the stereo baseline. w̅ₗ, w̅ᵣ:=the projection of the 3D motion (the ideal optical flow) of point in the scene onto the image planes in the left and right cameras.

We first derive equations for

$$\overline{h} ( {\overline{x}}_{l} ) = [ \begin{matrix}{h}_{x} ( {x}_{l} ) \\ {h}_{y} ( {y}_{l} )\end{matrix} ]$$

which is the disparity in x and y with the left image being the reference image. For the x direction, we start with the projection equations for a pinhole camera.

$$\begin{matrix}{x}_{l} = - \frac{{f}_{l} {X}_{l}}{{Z}_{l}} & ( 1 ) \\ {x}_{r} = - \frac{{f}_{r} {X}_{r}}{{Z}_{r}} & ( 2 )\end{matrix}$$

where

b=Xᵣ−Xₗ (3)

is the stereo baseline. Solving for the disparity in the x direction gives

$${x}_{l} = {x}_{r} = {h}_{x} = \frac{{f}_{r} {X}_{r}}{{Z}_{r}} - \frac{{f}_{l} {X}_{l}}{{Z}_{l}} \qquad ( 4 )$$

Reducing gives

$${h}_{x} = \frac{( - \frac{{f}_{r}}{{f}_{l}} {x}_{l} {Z}_{l} ) + {f}_{r} b + {x}_{l} {Z}_{l} - {x}_{l} d}{{Z}_{l} + d} \qquad ( 5 )$$

where d=Zₗ−Zᵣ is the difference in Z distance between the optical centers of the left camera and the right camera.

If the focal lengths in the left and right cameras are equal (e.g. d=0 and fₗ=fᵣ), equation (5) reduces to the well known binocular stereo disparity equation

$$h = \frac{fb}{Z} \qquad ( 6 )$$

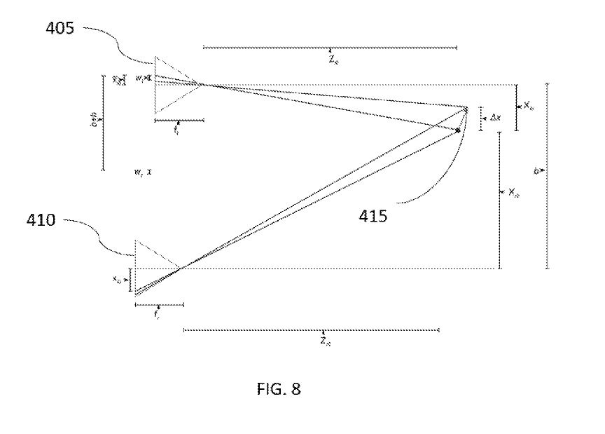

Referring to FIG. 8, the same method is used to derive the disparity in the y direction to arrive at

$${h}_{y} = \frac{{y}_{l} ( {Z}_{l} + d - \frac{{f}_{r}}{{f}_{l}} {Z}_{l} )}{{Z}_{l} + d} \qquad ( 7 )$$

This equation reduces to the equation for a traditional stereo epipolar line in a rectified image pair for d=0 and fₗ=fᵣ:

h_{y}(x_{f})=0 (8)

The relationship between the optical flow fields, which depends on both Z and ΔZ, is found next. Since the derivation is done using continuous derivatives, Ż is used instead of ΔZ, but when moving back to a discrete formulation Ż will be replaced with ΔZ. Starting with the projection equations and taking the derivatives with respect to time:

$$\begin{matrix}\frac{dx}{dt} = {w}_{x} = - f \frac{d}{dt} ( \frac{X}{Z} ) & ( 9 ) \\ \frac{dy}{dt} = {w}_{y} = - f \frac{d}{dt} ( \frac{Y}{Z} ) & ( 10 ) \\ {w}_{x} = \frac{x \dot{Z} - f \dot{X}}{Z} & ( 11 ) \\ {w}_{y} = \frac{y \dot{Z} - f \dot{Y}}{Z} & ( 12 )\end{matrix}$$

which can be written in homogeneous coordinates as:

$$\begin{matrix} \overline{P} = [ \begin{matrix}1 & 0 & x / f & 0 \\ 0 & 1 & y / f & 0 \\ 0 & 0 & 0 & - Z / f\end{matrix} ] & ( 13 ) \\ \overline{w} = [ \begin{matrix}1 & 0 & - x / f & 0 \\ 0 & 1 & - y / f & 0 \\ 0 & 0 & 0 & - Z / f\end{matrix} ] [ \begin{matrix}\dot{X} \\ \dot{Y} \\ \dot{Z} \\ 1\end{matrix} ] = [ \begin{matrix}\dot{X} - \frac{x \dot{Z}}{f} \\ \dot{Y} - \frac{y \dot{Z}}{f} \\ - \frac{Z}{f}\end{matrix} ] = - [ \begin{matrix}\frac{f \dot{X} - x \dot{Z}}{Z} \\ \frac{f \dot{Y} - y \dot{Z}}{Z}\end{matrix} ] & ( 14 )\end{matrix}$$

Adding image frame timing equations (11) and (12) give

$$\begin{matrix}{\overline{w}}_{l} = \frac{{x}_{l 0} \dot{Z} - {f}_{l} \dot{\overline{X}}}{{Z}_{l 1}} & ( 15 ) \\ {\overline{w}}_{r} = \frac{{x}_{r 0} \dot{Z} - {f}_{r} \dot{\overline{X}}}{{Z}_{r 1}} & ( 16 )\end{matrix}$$

for the first and second cameras. Solving for \overline{\dot{X}} and setting the resulting equations equal to each other gives

p(x̅ₗ)w̅ₗ(x̅ₗ)=g̅(x̅_{f})w̅ᵣ(x̅ₗ+h̅(x̅ₗ)) (17)

where

$$p ( {\overline{x}}_{l} ) = ( \frac{{f}_{l}}{{f}_{r}} ) ( \frac{{Z}_{r 1}}{{Z}_{l 1}} ) \qquad ( 18 )$$

and

$$\overline{g} ( {\overline{x}}_{1} ) = ( \frac{{f}_{1} {Z}_{r 1} {\overline{w}}_{r}}{{f}_{1} {Z}_{r 1} {\overline{w}}_{r} + {f}_{1} {\overline{x}}_{r 0} Z - {f}_{r} {\dot{\overline{x}}}_{10} \dot{Z}} ) \qquad ( 19 )$$

which can be written as an energy functional

E_{match}= [symbol] [p(x̅ₗ)w̅ₗ(x̅ₗ)−g̅(x̅ₗ)w̅ᵣ(x̅ₗ+h̅(x̅ₗ)]² (20)

Eₛₘₒₒₜₕ= [symbol] [|∇Zₗ(x̅ₗ)|+|∇Żₗ(x̅ₗ)|] (21)

Eₜₒₜₐₗ=γE_{match}+α̅Eₛₘₒₒₜₕ (22)

where

α̅=(αₓ, α_{y})^{T} (23)

### Operation—Optical Flow Field Alignment: Minimization of the Energy Functional

Equation (22) can be solved using a wide range of methods familiar to one skilled in the art. One preferred method finds the optical solution to the energy function using the variational methods technique. A second preferred method finds the optimal solution using the graph cuts technique.

### Operation—Optical Flow Field Alignment: Minimization of the Energy Functional Using Variational Methods: Euler-Lagrange

We rewrite (20) and (21) in continuous form and we re-express the smoothing term using an L2 norm

$$\begin{matrix}{E}_{match} = \frac{1}{2} {\int }_{a}^{b} {[ p ( {\overline{x}}_{l} ) {\overline{w}}_{l} ( {\overline{x}}_{l} ) - \overline{g} ( {\overline{x}}_{l} ) {\overline{w}}_{r} ( {\overline{x}}_{l} + \overline{h} ( {\overline{x}}_{l} ) ) ]}^{2} d \overline{x} & ( 24 ) \\ {E}_{smooth \_ Z} = \frac{1}{2} {\int }_{a}^{b} {‖ ∇ {Z}_{l} ( {\overline{x}}_{l} ) ‖}^{2} d \overline{x} & ( 25 )\end{matrix}$$

where

$$\begin{matrix}p ( {\overline{x}}_{l} ) = ( \frac{{f}_{l}}{{f}_{r}} ) ( \frac{{Z}_{r 1}}{{Z}_{l 1}} ) & ( 26 ) \\ \overline{g} ( {\overline{x}}_{l} ) = ( \frac{{f}_{l} {Z}_{r 1} {\overline{w}}_{r}}{{f}_{l} {Z}_{r 1} {\overline{w}}_{r +} {f}_{l} {\overline{x}}_{r 0} \dot{Z} - {f}_{r} {\overline{x}}_{l 0} \dot{Z}} ) & ( 27 )\end{matrix}$$

The first variation of equations (24) and (25) can now be taken with respect to Z and set to 0.

γw_{z}(p′wₗ+pw′ₗ−g̅′wᵣ(px)

−g̅w′ᵣ(px)p′x)−α̅∇²Z₁=0 (28)

where

$$\begin{matrix} {p}^{′} = \frac{\partial p}{\partial Z} = ( \frac{{f}_{b}}{{f}_{f}} ) ( \frac{1}{{Z}_{l 1}} + \frac{{Z}_{r 1}}{{( {Z}_{l 1} )}^{2}} ) & ( 29 ) \\ {w}_{l}^{′} = \frac{\partial {w}_{l}}{\partial Z} = - \frac{{w}_{l}}{{Z}_{l}} & ( 30 ) \\ {w}_{r}^{′} = \frac{\partial {w}_{r}}{\partial Z} = - \frac{{w}_{r}}{{Z}_{r}} & ( 31 ) \\ {g}^{′} = \frac{\partial g}{\partial Z} = \frac{{f}_{l} {w}_{r} + {f}_{l} {Z}_{r 1} {w}_{r}^{′}}{{f}_{l} {Z}_{r 1} {w}_{r} + {f}_{l} {x}_{r 0} \dot{Z} - {f}_{r} {x}_{l 0} \dot{Z}} + \frac{( {f}_{l} {Z}_{r 1} {w}_{r} ) ( {f}_{l} {w}_{r} + {f}_{l} {Z}_{r 1} {w}_{r}^{′} )}{{( {f}_{l} {Z}_{r 1} {w}_{r} + {f}_{l} {x}_{r 0} \dot{Z} - {f}_{r} {x}_{l 0} \dot{Z} )}^{2}} & ( 32 )\end{matrix}$$

The Euler-Lagrange equations (one for the x direction and the other for the y direction) are solved using the gradient descent method a method well known to one skilled in the art.

The gradient decent is initialized by taking the optical flow in the center pixel of the image from the first image sensor and estimating the scaled optical flow and disparity for Z={1, 2, 3, . . . } that should be perceived by the second image sensor based on the camera rig geometry. When the estimated disparity and optical flow intersect with the actual disparity and optical flow value from the optical flow field computed from images from the second image sensor the result is an estimate of the depth at that point. Using this estimate of depth at one location, the \dot{X} velocity can be found. Z at all points can then be estimated using \dot{X}. The Z estimate will contain errors in many if not most locations for a number of reasons, but this method produces a usable initial estimate.

### Operation—Optical Flow Field Alignment: Minimization of the Energy Functional Using Variational Methods: Algorithm

Compute w̅ₗ and w̅ᵣ.
Smooth w̅ₗ and w̅ᵣ.
Initialize Z
Iterate until stopping condition met
   For each epipolar line:
      Update Z estimate for one gradient descent step
      Compute Ż
      Update g(x̅ₗ)

### Operation—Optical Flow Field Alignment: Minimization of the Energy Functional Using Graph Cuts

Graph cuts have been effectively used to solve a number of energy minimization problems related to early vision that can be written in the form

E( [symbol] )= [symbol] D( [symbol] )_{data}+ [symbol] V( [symbol] )ₛₘₒₒₜₕ (34)

Where [symbol] is a finite set of labels, D( [symbol] )_{data} is a data matching energy term, V( [symbol] )ₛₘₒₒₜₕ is a smoothness term, and E( [symbol] ) is the total global energy to be minimized. In the preferred embodiment, the Boykov-Kolmogorov algorithm is used, although one skilled in the art could apply any graphing approach to minimize the energy functional.

In network flow problems, graph theory is the study of graphs, which consist of a set of nodes or vertices V connected by arcs or edges ε. The graph is an ordered pair of vertices and edges g=(V, ε). Each edge is an ordered pair of two vertices (p, q). Ordered pairs of vertices are assigned edge costs or edge weights. If the cost between vertices (p, q) is the same as the cost between (q, p) then the graph is call undirected. If the costs depend on the order of the vertices, then the graph is called directed.

Graphs typically contain two special vertices (terminals) called the sink t and the source s. In computer vision problems, the vertices are typically pixels and the edges represent the pixel neighborhood.

In graph theory, a cut partitions the vertices into two subsets [symbol] and [symbol] where [symbol] contains the source terminal s and [symbol] contains the sink terminal t. This is called an sit cut C={ [symbol] , [symbol] }. The cost of a cut C is the sum of the costs of all the edge which link a vertex in [symbol] to vertex in [symbol] . A minimum cut is the partition of vertices into two disjoint sets that produces the minimum cost.

A min-cut problem can also be formulated as a max-flow problem where each edge has a maximum flow capacity that can pass through the edge. With the exception of the source and sink terminals, each vertex must have the same flow into and out of the vertex. This is called the conservation of flow constraint. The source terminal only has flow out and the sink terminal only has flow in. The Max-Flow, Min-Cut theorem of Ford and Fulkerson states that the maximum flow from s to t saturates a set of edges. This set of saturated edges partitions the vertices in two disjoint sets [symbol] and [symbol] which is the same partition which produces the minimum cut.

A minimum cut partitions a group of pixels (vertices) into two disjoint sets one containing the source and one containing the sink along some minimum global energy. For stereo correspondence finding, the graph can be thought of as a 3D cube with the x and y dimensions being the pixels in the image and the z dimension being disparity, thus each vertex represents a pixel at a specific disparity. An s/t cut is then a 3D surface that partitions the pixels/disparity combination along a disparity surface which produces the minimum global energy.

Numerical solutions to min-cut/max-flow problems fall into one of two main groups: augmenting path methods and preflow-push (or push-relabel) methods. Augmenting path algorithms based on the original Ford-Fulkerson approach, perform a global augmentation by pushing flow into paths between the source and sink that are not yet saturated. In push-relabel algorithms the flow is pushed along individual edges. This violates the conservation of flow constraint during intermediate stages of the algorithm, but generally produces a more computationally efficient result.

The Boykov-Kolmogorov algorithm is based on the augmenting path algorithm, but with two main differences. Unlike traditional augmenting path algorithms, which build a breadth-first search tree from the source to the sink, the Boykov-Kolmogorov algorithm builds two search trees, one from the source to the sink and a second from the sink to the source. The second difference is that the Boykov-Kolmogorov algorithm reuses the search trees instead of rebuilding them after each path of a certain length is saturated. Rebuilding the search trees is a computationally expensive component of the algorithm as it involves scanning the majority of pixels in the images.

In the Boykov-Kolmogorov algorithm, the two search trees consist of active and passive vertices. Active vertices are those that can grow and passive vertices cannot grow because they are blocked by surrounding nodes. The algorithm iterates through three stages, the grow stage, the augmentation stage, and the adoption stage.

In the growth stage of the algorithm, paths are grown from both the source and the sink. Growth occurs into all neighboring active vertices using non-saturated edges. This stage stops when an active vertex from one tree encounters a neighboring vertex in the other tree. The result of the grow stage is a path from the source to the sink.

In the augmentation stage, the largest flow possible is pushed along the path between the source and the sink. This generates a certain number of saturated edges. Saturated edges typically result in some vertices becoming what Boykov calls “orphans”. An orphan has been disconnected from the trees that start from the source and the sink terminals and becomes the roots of a new tree. These new trees, however, do not contribute to the flow between the source and sink.

In the adoption stage, the two-tree structure (one with the source as its root and one with the sink as its root) is restored. This is done by either finding a valid parent for the orphans or if a valid parent cannot be found, by removing the orphans.

The algorithm repeatedly iterates through the three stages until the two trees can no longer grow and all the edges that connect the two trees are saturated. The fact that all the edges that connect the two trees are saturated implies that this is a maximum flow. In tests performed by Boykov and Kolmogorov, their algorithm performed 2-5 times faster than all other methods.

Referring to equation (34), [symbol] is a set of observations (e.g. pixels) and [symbol] is a finite set of labels (e.g. disparity values in traditional binocular stereo correspondence finding). D computes a cost of assigning a particular label [symbol] to pixel p and V is a regularization term which favors spatial smoothness. The objective is to assign each observation p a label [symbol] such that the sum over all pixels [symbol] minimizes the global energy E( [symbol] ).

[symbol] is defined as the finite set of (Z, Ż) pairs as follows:

[symbol]

={(Zₘᵢₙ, −Żₘᵢₙ), (Zₘᵢₙ+1, −Żₘᵢₙ), (Zₘᵢₙ+2, −Żₘᵢₙ), . . . , (Żₘᵢₙ, −Żₘᵢₙ+1), (Zₘᵢₙ+1, −Żₘᵢₙ+1), (Zₘᵢₙ+2, −Żₘᵢₙ+1), . . . , (Zₘₐₓ, −Żₘₐₓ+1)} (35)

The matching term (16) penalizes the difference between the optical flow in the reference image at pixel [symbol] and the optical flow in the sensed image at [symbol] +h̅( [symbol] ) when the optical flow is adjusted for the difference in magnification which depends on the ratio of the focal lengths in the two systems and the ratio of the different Z distances of the two cameras. This is a two component penalty as both components (wₓ, w_{y}) of the optical flow contribute to the cost.

E( [symbol] )ₛₘₒₒₜₕ is the sum over all pairs of neighboring pixels ( [symbol] , q,) in the reference image, where ( [symbol] , q,) are 4-connected. This cost defines the pixel neighborhood structure and assigns a linear penalty (L1) to neighboring pixels that have different labels. This is also a two component penalty as both the difference in the Z component of the label and the difference in Ż component of the label contribute to the smoothness penalty.

The global energy has two notable differences when compared to a traditional binocular stereo energy: 1) in matching optical flow, each pixel location in the reference frame has two values, one for the optical flow in the x direction and a second for the optical flow in the y direction and 2) we solve directly and simultaneously for Z and Ż.

### Operation—Optical Flow Field Alignment: Minimization of the Energy Functional Using Graph Cuts: Algorithm

Compute w̅_{f} and w̅_{b}.
Construct the cost matrix
Construct the neighborhood matrix
Define the smoothness costs
Find the minimum cut

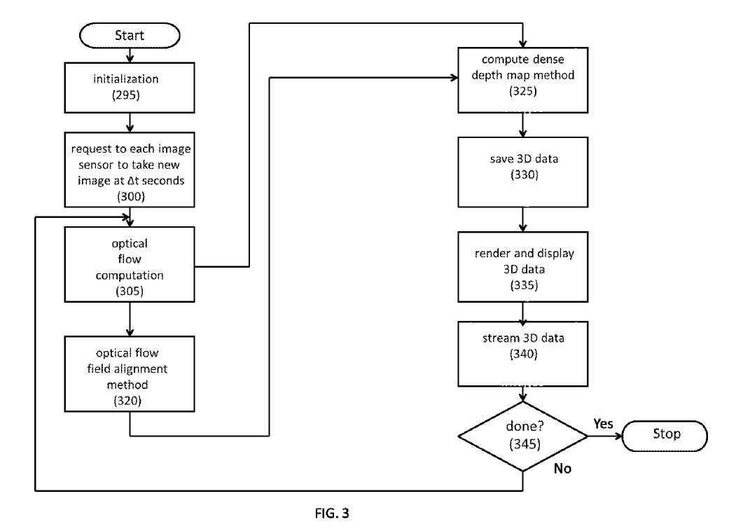

FIG. 3 shows a flow chart of the computer code implemented in the processor 270 of the block diagram of FIG. 2. In the preferred embodiment, the initialization 295 routine initializes all variables and peripheral devices like image sensors, displays, and input/output devices. The computer code then initiates a repeating request to each image sensor to take new images at Δt second intervals 300. When received, each successive pair of images are sent to the optical flow algorithms where an optical computation 305 is performed. The optical flow fields from each image sensor are passed to an optical flow field alignment method (320) using an energy minimization technique. Disparity and the ratio of optical flow values are then passed to a compute dense depth map method (325). The data is sent to a save 3D data (330) method, and optionally sent to a render and display 3D data (335) method and a stream 3D data (340) method. The process repeats until it is done (345)

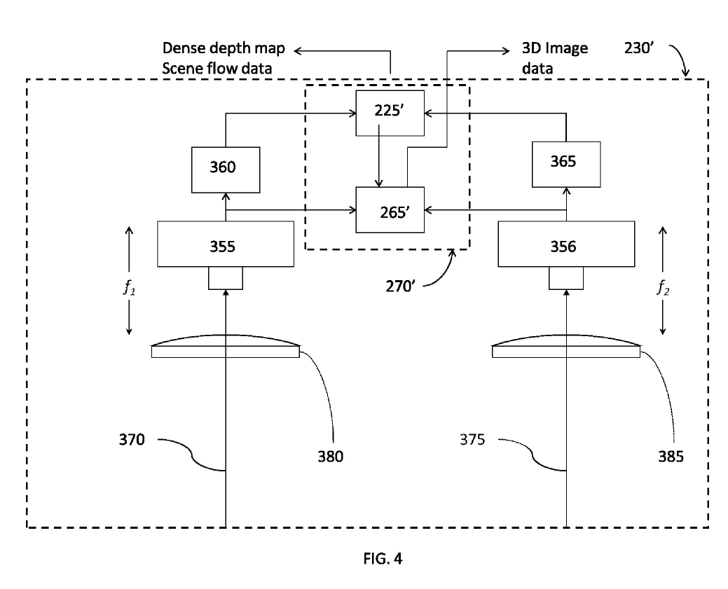

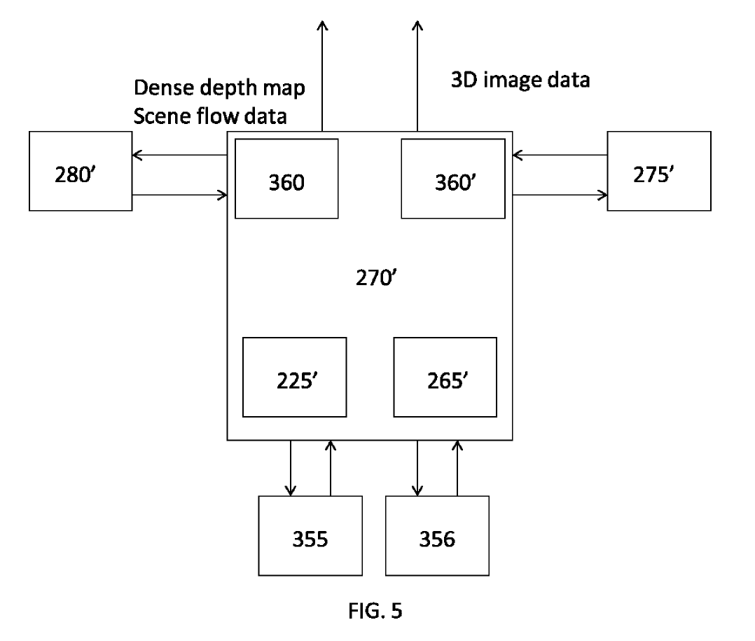

### Additional Embodiments—FIGS. 4-5

FIG. 4 is a schematic representation showing the optical system, imaging system and image processing system of an additional preferred embodiment of the invention. A first image sensor, sensing first light frequency range 355, images along an optical axis of first image sensor 370 via a first imaging lens 380. A second image sensor, sensing second light frequency range 356 images along an optical axis of second image sensor 375 via a second imaging lens 385. The image formed in the first image sensor, sensing a first range of light frequencies 355 having a partial overlap with the image formed in the second image sensor, sensing a second light frequency range 356.

In this preferred embodiment, the optical axis of the first image sensor 370 and the optical axis of second image sensor 375 are parallel, however one skilled in the art will be able to conceive of numerous ways to orient the optical axis to permit a partial overlap of the resulting images.

In an additional preferred embodiment, the first image sensor, imaging light in first light frequency range 355 is in communication with a first optical flow processor 360, which may be a computer program implemented on a general-purpose processor, in an Field Programmable Gate Array (FPGA), Application Specific Integrated Circuit (ASIC), discrete state engine, a graphic processing unit or similar device. One skilled in the art will be able to conceive of numerous ways of implementing a combination image sensor and optical flow processor. The second image sensor, imaging light in second light frequency range 356 is in communication with a second optical flow processor 365. One skilled in the art can appreciate the first optical flow processor 360 and the second optical flow processor 365, may be one in the same and shared by the two image sensors.

The first image sensor, sensing first light frequency range 355 may have a range of pixel counts and resolutions as well as frame rates. In one preferred embodiment, the first image sensor 355 is 640×480 pixels, each pixel being 4.8 μm×4.8 μm, having a frame rate of 30 fps, and detecting color images. Image sensors with any size pixels and a range of frames rate could also be used as long as there is sufficient overlap between sequential images to produce optical flow. Monochrome image sensors may be used. IR image sensors may be used. In one preferred embodiment, the first imaging lens 380 has a first focal length of 6 mm. The imaging system may have lenses comprised of multiple optical components, a single lens or may use a pinhole to form the image. One skilled in the art will have no difficulty designing an imaging system capable of producing an image on the image planes of first image sensor, sensing first light frequency range 355.

The second image sensor, sensing second light frequency range 356 may have a range of pixel counts and resolutions as well as frame rates. In one preferred embodiment, the second image sensor 206 is 640×480 pixels, each pixel being 4.8 μm×4.8 μm, having a frame rate of 30 fps, and detecting IR images. The pixel count, pixel size, and frame rate need not be the same as the first image sensor 355. Image sensors with any size pixels and a range of frames rate could be used. Color image sensors may be used. IR image sensors may be used. In one embodiment, the second imaging lens 385 has a second focal length of 8 mm. The imaging system may have multiple lenses or may use a pinhole to form the image. One skilled in the art will have no difficulty designing an imaging system capable of producing an image on the image planes of second image sensor, sensing second light frequency range 356.

In addition to being in communication with optical flow processors 360 and 365 the images acquired by the first image sensor, sensing first light frequency range 355 and the second image sensor, sensing second light frequency range 356 may be in communication with an image processor 265′ which combines the dense depth map with the 2D image data to output rendered 3D image data.

The output of the optical flow field from each of the optical flow processors is fed into a 3D reconstruction processor 225′ that aligns pairs of flow fields and uses the aligned flow fields to compute dense depth maps and scene flow. The algorithm used by the 3D reconstruction processor 225′ is described under the operation section of this application. In one preferred embodiment, the 3D reconstruction processor 225′ and the image processor 265′ are implemented in subroutines in processor 270′, but one skilled in the art can appreciate that these functions could be implemented numerous different ways including in discrete components or separate dedicated processors.

FIG. 5 is a block diagram of the above described preferred embodiment. The components of the system are in communication with processor 270′ which could be computer code running on a computer processor, discrete logic components, or any number of other implementations familiar to one skilled in the art. In the preferred embodiment, processor 270′ is in communication with the image sensors 355 and 356.

In FIG. 5, processor 270′ is in communication with memory 275′ and input/output devices 280′ which could be any combination of displays, keyboards, mice, 3D virtual reality goggles, or any other input/output device known to those skilled in the art. The processor 270′ also streams 3D position data, 3D velocity data, and 3D image data.

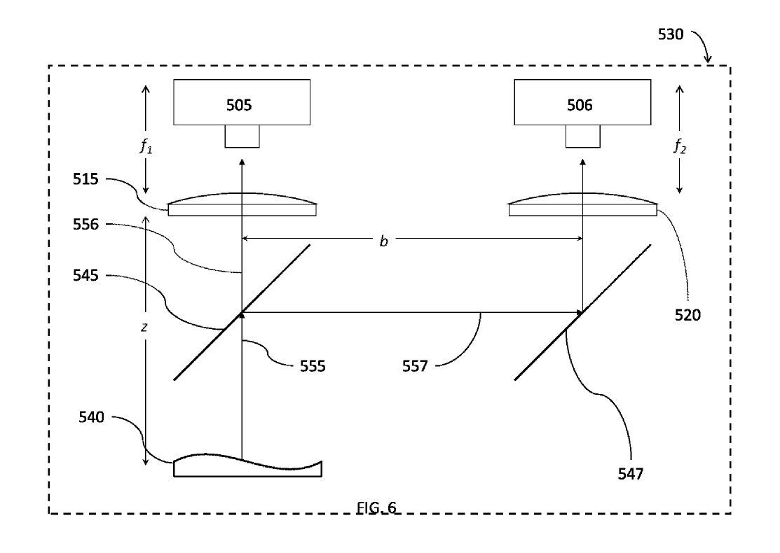

FIG. 6 is a schematic representation of the imaging system of an additional preferred embodiment of the scene flow camera where the image sensors are aligned coaxially. An image enters the optical system along a coaxial optical path 555, passes through a beam splitter 545 and is split into a first independent optical path 556 and a second independent optical path 557. The second independent optical path 557 is longer than the first optical path 556 by a baseline b, which can be partitioned into a horizontal component and a vertical component. The second independent optical path 557 passes through a mirror 547.

The first independent optical path 556 passes through a first imaging lens 515 with a focal length of f₁ and is imaged by a first image sensor 505. The second independent optical path 557 passes through a second imaging lens 520 with a focal length of f₂ and is imaged by a second image sensor 506.

In one preferred embodiment, the first imaging lens has a focal length of 6 mm although any suitable imaging system will work that is capable of focusing an image of a surface in a 3D scene 540 on the image plane of the first image sensor 505. In one preferred embodiment, the baseline b is 64 mm. In one preferred embodiment, the second imaging lens has a focal length of 8 mm although any suitable imaging system will work that is capable of focusing an image of surface 540 on the image plane of the second image sensor 506. The two different optical paths can vary in a multitude of ways as long as a change in the Z-distance causes different magnifications of the resulting images in image sensor 505 and in image sensor 506. It is acceptable to have identical magnifications of the two systems at one Z-distance as long as it is not identical for every Z-distance. One skilled in the art will be able to design an imaging system for the two image sensors that have differing magnifications.

The surface in 3D scene 540 being imaged may have a flat surface parallel to the image plane, or it may have surface variations. Additionally, there may be several surfaces in the scene at various different distances from the image sensors and moving at different velocities relative to each other or the surface may be dynamically deformable.

First Image sensor 505 and second image sensor 506 may have different pixel sizes and counts. First image sensor 505 and second image sensor 506 may image different modalities of light, for example color and monochrome or color and infrared (IR). In one preferred embodiment, the two image sensors have the same number of pixels and in another preferred embodiment, the number of pixels are different in relation to the difference in magnification of the two optical systems near the center of the working range of the system. Another preferred embodiment combines a color and IR image sensor to broaden the range of optical information.

The beam splitter 547 can be any device that splits the incoming light into two optical paths. In one preferred embodiment, the beam splitter is a 50%/50% plate beam splitter.

The computational components of this preferred embodiment are identical to that of the above described preferred embodiments.

### Advantages

From the description above, a number of advantages of the 3D surface mapping system of this invention become evident:
(1) pairs of images are acquired at the same or at different light wavelengths.
(2) Images are aligned using motion between successive image pairs, eliminating the need for visual similarity between the images acquired at different light frequencies or under different lighting conditions. This results in more accurate dense depth maps than state-of-the-art methods.
(3) 3D reconstruction is performed using standard rendering technique using dense depth maps from aligned optical flow fields from pairs of images.
(4) 3D scene flow is estimated using the optical flow fields and the dense depth maps.
(5) dense depth maps and scene flow can be estimated using a coaxial camera which allows imaging through a tube.

### CONCLUSION, RAMIFICATIONS, AND SCOPE

Accordingly, the reader will see that this invention provides image alignment, dense depth maps, 3D reconstruction, and scene flow estimation from image sequences that are acquired at different light frequencies or under different lighting conditions without relying on visual similarity measures between images. Additional, image alignment, dense depth maps, 3D reconstruction, and scene flow estimation can be done using a coaxial camera arrangement, something which is not possible using traditional methods that rely on visual similarity.

Although the description above contains many specificities, these should not be construed as limiting the scope of the invention but as merely providing illustrations of some of the presently preferred embodiments of this invention. It will be apparent to one skilled in the art that the invention may be embodied still otherwise without departing from the spirit and scope of the invention.

Thus, the scope of the invention should be determined by the appended claims and their legal equivalents, rather than by the examples given.

I claim:

1. A scene flow camera, comprising the steps of:
providing a first and a second means of obtaining sequential images of a 3D surface;
acquiring sequential images with said first and second means of obtaining sequential images;
providing at least one computational means of computing optical flow fields from said sequential images obtained by said first and second means of obtaining sequential images;
and providing a computational means for aligning said optical flow fields.

2. The method of claim 1, where said first and second means of obtaining sequential images of said surface, image along substantially coaxial optical paths.

3. The method of claim 2, where said substantially coaxial optical path is inside a tube.

4. The method of claim 1, where said first and second means of obtaining sequential images of said surface are sensitive to a first and a second range of light frequencies.

5. The method of claim 1, where the computation means for aligning said optical flow fields uses an energy optimization technique.

6. The method of claim 1, providing a computational means for computing dense depth maps from said optical flow fields.

7. The method of claim 1, further providing a means of computing scene flow.

8. A scene flow camera, comprising:
a first and a second means of obtaining sequential images of a 3D surface;
said first and second means of obtaining sequential images in communication with at least one means of computing an optical flow field;
said means of computing an optical flow field in communication with a computational means for aligning said optical flow fields.

9. The scene flow camera of claim 8, where said first and second means of obtaining sequential images of said 3D surface, image along substantially coaxial optical paths.

10. The scene flow camera of claim 9, where said substantially coaxial optical path is inside a tube.

11. The scene flow camera of claim 8, where, said first and second means of obtaining sequential images of said surface are sensitive to a first and a second range of light frequencies.

12. The scene flow camera of claim 8, where the computation means for aligning said optical flow fields uses an energy optimization technique.

13. The scene flow camera of claim 8, further providing a means of computing dense depth maps.

14. scene flow camera, comprising:
a first and a second image sensor;
said first and second image sensors in communication with at least one optical flow computation engine;
and a computation engine for computing the alignment between optical flow fields.

15. The scene flow camera of claim 14, where said first and second image sensors, image along substantially coaxial optical paths.

16. The scene flow camera of claim 14, where said first and second image sensors are sensitive to a first and a second range of light frequencies.

17. The scene flow camera of claim 14 where said computation engine for computing the alignment between optical flow fields uses an energy optimization technique.

18. The scene flow camera of claim 14, further comprising a computational engine for computing dense depth maps.

19. The scene flow camera of claim 14, further comprising a computational engine for rendering said dense depth map into a 3D reconstruction.

20. The scene flow camera of claim 15, where said substantially coaxial optical path is inside a tube.
